(19) United States
(12) Patent Application Publication
(10) Pub. No.: US 2010/0114372 A1
(43) Pub. Date: May 6, 2010

(54) METHOD OF CLEANING A SURFACE USING AN AUTOMATIC CLEANING DEVICE

(75) Inventors: David M. Knuth, JR., Dubuque, IL (US); Henry L. Hillman, JR., Vancouver, WA (US)

Correspondence Address: PEPPER HAMILTON LLP, ONE MELLON CENTER, 50TH FLOOR, 500 GRANT STREET, PITTSBURGH, PA, 15219, US

(73) Assignee: INTELLIBOT ROBOTICS LLC, Richmond, VA (US)

(21) Appl. No.: 12/261,703

(22) Filed: Oct. 30, 2008

(51) Int. Cl. G05B 19/00; A47L 11/00

(52) U.S. Cl. 700/257; 15/4

(57) ABSTRACT

A method of cleaning a surface using an automatic cleaning device may include learning, by an automatic cleaning device, one or more cleaning methods. Each cleaning method may be associated with a code corresponding to a radio frequency identification tag positioned in a vicinity of a surface to be cleaned. The method may also include receiving, by the automatic cleaning device, a target code from a target radio frequency identification tag positioned in a vicinity of a target surface to be cleaned, determining the cleaning method associated with the target code and applying the associated cleaning method to the target surface when the target radio frequency identification tag is detected.

### BACKGROUND

Automatic cleaning devices have minimized the human effort involved in maintaining and cleaning surfaces, such as hardwood floors, carpet and the like. Mobile robotic cleaning devices are especially useful, but location detection can be a challenge for the operation of such devices.

In some systems, an automatic robotic cleaning device responds to radio frequency identification device (RFID) tags placed along a floor surface. An example of such a system is disclosed in U.S. Patent Application Publication No. 2006/0293794, filed by Harwig et al. In such a system, each RFID tag may include an antenna and a transceiver chip. An RFID reader may also include an antenna which the reader may power to generate an RF excitation field. When an RFID tag is exposed to the RF excitation field, the tag will generate a signal that the RFID reader can receive and decode to obtain information. For example, an automatic cleaning device may use a signal received from an RFID tag to determine the tag's position in a room, to navigate a course or the like.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “code” is a reference to one or more codes and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

In an embodiment, a method of cleaning a surface using an automatic cleaning device may include learning, by an automatic cleaning device, one or more cleaning methods. Each cleaning method may be associated with a code corresponding to a radio frequency identification tag positioned in a vicinity of a surface to be cleaned. The method may also include receiving, by the automatic cleaning device, a target code from a target radio frequency identification tag positioned in a vicinity of a target surface to be cleaned, determining the cleaning method associated with the target code and applying the associated cleaning method to the target surface when the target radio frequency identification tag is detected.

In an embodiment, a method of learning, by an automatic cleaning device, how to clean a surface may include receiving one or more instructions for cleaning a surface. The instructions may instruct the automatic cleaning device to apply a cleaning method to the surface. The cleaning method may be associated with a code. The method may also include storing one or more of the received instructions, the cleaning method and the associated code.

In an embodiment, a method of learning, by an automatic cleaning device, how to clean a surface, may include navigating a surface having one or more radio frequency identification tags and, for each encountered radio frequency identification tag, receiving a code from the radio frequency identification tag, mapping the received code to one or more instructions for performing a cleaning method, and storing one or more of the received code, the one or more instructions and the associated cleaning method.

### BRIEF DESCRIPTION OF THE DRAWINGS

FIG. 1 illustrates a diagram of an exemplary area that may be cleaned by an automatic cleaning device according to an embodiment.

FIG. 2 depicts a flow diagram for an exemplary method of cleaning a surface according to an embodiment.

FIG. 3 depicts a method of learning, by an automatic cleaning device, how to clean an area or other defined space according to an embodiment.

FIG. 4 depicts an exemplary area to be cleaned according to an embodiment.

FIG. 5 illustrates an flow chart of a method of cleaning the area according to an embodiment.

### DETAILED DESCRIPTION

The following terms shall have, for the purposes of this application, the meanings set forth below.

An “automatic cleaning device” is a mobile robot that can automatically navigate and clean surfaces, such as floors.

A radio frequency identification (RFID) tag is a device having a memory, an antenna and the ability to receive radio frequency signals. An RFID tag may be incorporated into a product for the purpose of identification. In an embodiment, an RFID tag's memory may be part of an integrated circuit (IC) transceiver chip. The IC transceiver chip may be connected to the antenna which may transmit RF signals from the IC transceiver chip and may receive incoming RF excitation signals. The IC transceiver chip may include an RF receiver and an RF transmitter, which may both be connected to the antenna. Alternatively, a chipless RFID device may be printed directly on another item without an IC.

When an RFID tag is exposed to an RF excitation field, such as an incoming RF signal, the tag may generate a signal that an RFID reader may receive and decode to obtain information. In an embodiment, an automatic cleaning device may include an RFID reader that may receive signals from the RFID tag. The automatic cleaning device may also include a controller that may interpret the signals received by the RFID reader to provide cleaning instructions. The automatic cleaning device also may include an RFID transmitter that generates and transmits the RF excitation field.

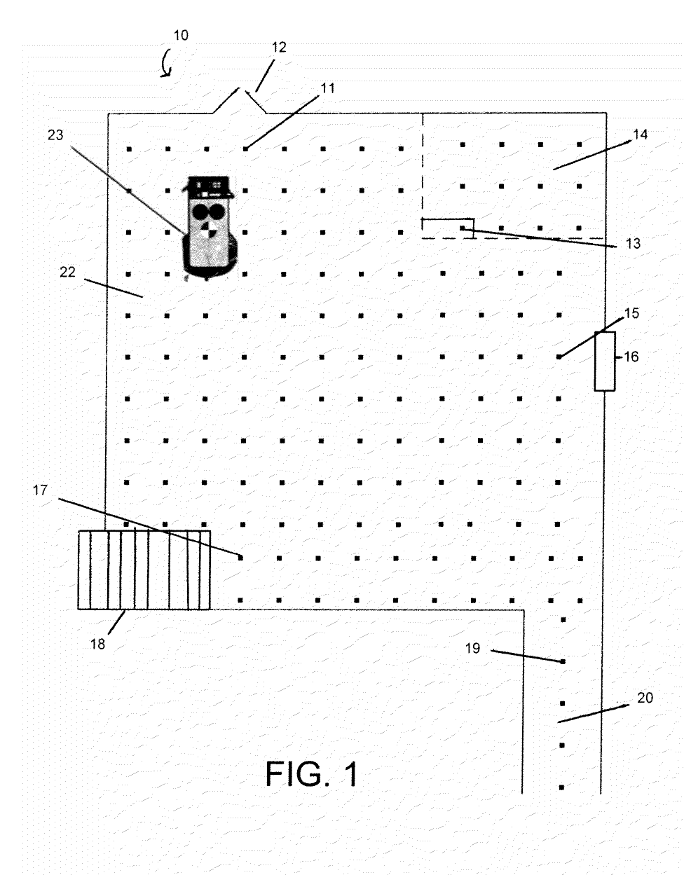

FIG. 1 illustrates a diagram of an exemplary area that may be cleaned by an automatic cleaning device 23 according to an embodiment. In an embodiment, the cleaning method used on a particular surface may vary according to a feature of the surface. As illustrated by FIG. 1, an area 10 may include one or more surfaces having one or more features. For example, a surface may be located near a doorway 12 and, as such, the surface may be located in a high-traffic area. The same may be true for surfaces located near stairways 18 or elevators 16. In an embodiment, a feature of a surface may include a floor type. For example, a hallway 20 may be hardwood, another surface 22 may be carpet and a different surface 14 may be tile.

In an embodiment, one or more RFID tags may be positioned in an area to identify one or more features associated with a particular surface. In an embodiment, the RFID tags may be embedded in a surface. Alternatively, the RFID tags may be positioned on a surface by any suitable means. In an embodiment, the RFID tags may be spaced a certain distance away from each other.

The RFID tags may communicate the appropriate cleaning method for the surface to an automatic cleaning device. For example, an RFID tag 11, 17, 15 located near a doorway 12, a staircase 18 or an elevator 15 may identify the surfaces of these high-traffic areas as requiring an intense cleaning. Similarly, an RFID tag 13 located on a carpeted surface 22 may identify this surface as requiring vacuuming.

In an embodiment, an automatic cleaning device may include memory, such as ROM and/or RAM, that includes one or more programming instructions. Alternatively, the programming instructions may be stored on a tangible computer-readable medium such as a compact disk, a digital disk or other recording medium. In an embodiment, one or more of the programming instructions may correspond to a particular code stored on an RFID tag. When the automatic cleaning device receives a code from an RFID tag, it may match the code to one or more stored instructions and perform the cleaning method associated with the one or more programming instructions. In an embodiment, information associated with an automatic cleaning device's encounter with an RFID tag may be stored on the RFID tag. For example, the date the automatic cleaning device encountered the RFID tag, the time the automatic cleaning device encountered the RFID tag and/or the like may be stored.

In an embodiment, each cleaning method may be associated with a code corresponding to an RFID tag positioned on a surface. An RFID tag may store information, such as a unique code that allows a receiver to identify a surface, area or location where it is positioned. Alternatively, an RFID tag may store a code corresponding to a cleaning method associated with the surface. Cleaning methods may be based upon one or more features of a surface such as, for example, a floor type (i.e., hardwood, plush carpet, tile), a traffic area (i.e., low-traffic area, moderate-traffic area, high-traffic area), a location (i.e., near an elevator, near a stairwell) and/or the like.

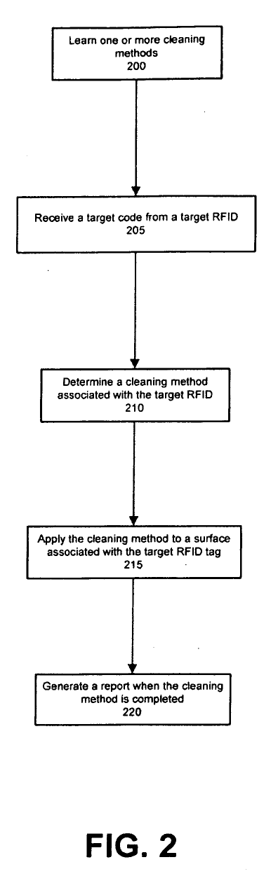

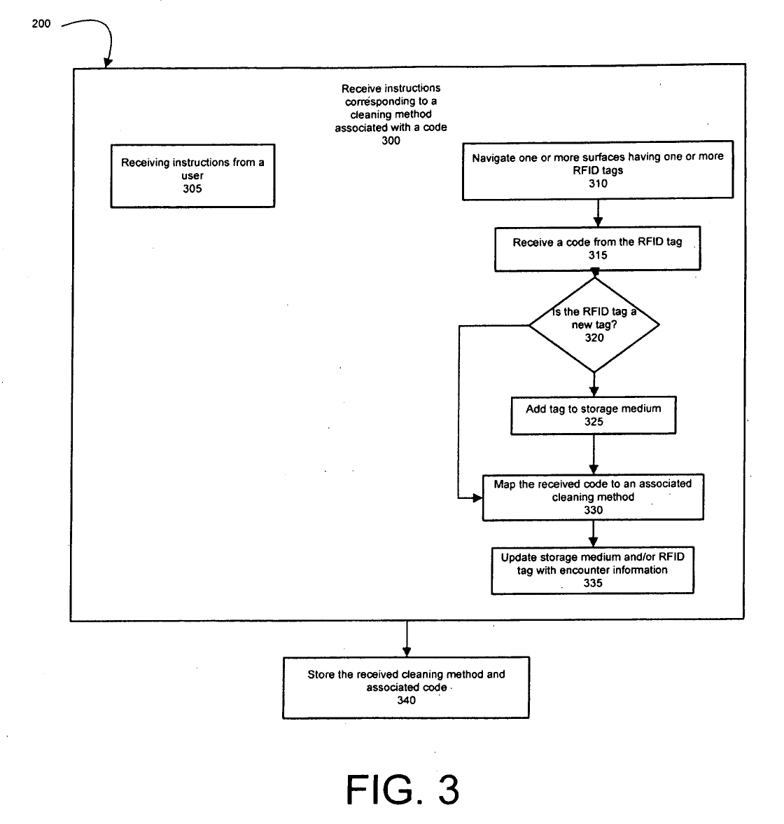

FIG. 2 illustrates a flow diagram of an exemplary method of cleaning a surface using an automatic cleaning device according to an embodiment. In an embodiment, an automatic cleaning device may learn 200 how to clean a room or other defined space as illustrated by FIG. 3.

Referring to FIG. 3, in a learning process 200, an automatic cleaning device may receive 300 a cleaning method associated with a code received from an RFID tag according to an embodiment. For example, an automatic cleaning device may learn one or more cleaning methods by receiving 305 input instructions from a user corresponding to a cleaning method associated with a surface and storing 325 the input instructions in a computer-readable memory.

In an embodiment, an automatic cleaning device may include a graphical user interface that may allow a user to provide one or more settings. For example, the automatic cleaning device may display one or more surface types, or RFID codes where each code is associated with a surface type. Alternatively, the user may enter the instructions remotely via a wired or wireless communication link. The user may specify the cleaning method to be applied to the one or more surfaces that are in the vicinity of the RFID tag. In an embodiment, the user may select a check box, a radio button, a drop down box or the like in the graphical user interface to select the cleaning method. The user may also enter a cleaning method using a keyboard, a mouse, a joystick or the like. Additional and/or alternate selection methodologies may be used within the scope of this disclosure.

In an embodiment, a user may enter login information to access the graphical user interface. Login information may include a unique identifier, a user name, a passcode, a password and/or the like. Alternatively, a user may have an RFID tag located on their person that includes the login information associated with the user. An automatic cleaning device may receive the login information from the user's RFID tag, and may use this information to automatically grant the user access to the graphical user interface.

In an embodiment, an automatic cleaning device may learn how to clean an area or other defined space by navigating 310 one or more surfaces having one or more RFID tags. For example, if the automatic cleaning device is being used in a house, it may be instructed to navigate 310 within and between certain rooms in the house. The automatic cleaning device may encounter one or more RFID tags in a particular area. The automatic cleaning device may determine whether an encountered tag is a new tag. If so, the automatic cleaning device may receive 315 instructions which it may store so that it develops a memory. For example, the automatic cleaning device may receive 315 a code from an encountered RFID tag and may map 330 the received code to an associated cleaning method using a computer-readable storage medium, such as a database. Mapping 330 may involve matching the received code to one or more instructions for performing a corresponding cleaning method.

In an embodiment, if the encountered tag is a new tag 320, it may be added 325 to the computer-readable storage medium. For each encountered RFID tag, the computer-readable storage medium may be updated 335 with information regarding the encounter, such as the time of the encounter, the date of the encounter and/or the like. In an embodiment, the corresponding RFID tag may be updated 335 with information regarding an encounter.

In an embodiment, once a cleaning method is identified for an area near a tag, the automatic cleaning device may store 340 the cleaning method and associated code. In an embodiment, the cleaning method and associated code may be stored 340 on the automatic cleaning device. Alternatively, the cleaning method and associated code may be stored 340 remotely, and may be accessible by the automatic cleaning device via a wireless connection or the like.

Referring back to FIG. 2, after learning 200 a set of instructions associated with cleaning an area, an automatic cleaning device may then clean the area. First, the automatic cleaning device may receive 205 a target code from a target RFID tag. The automatic cleaning device may use the target code to determine 210 a cleaning method associated with the target RFID tag. For example, an RFID tag may store the code “001.” In an embodiment, upon receiving this code from the RFID tag, the RFID reader may match the code to one or more instructions for performing a cleaning method using, for example a database. In an embodiment, the database may be stored on the automatic cleaning device. Alternatively, the database may be stored remotely and may be accessible by the automatic cleaning device via a wireless connection or the like. Table 1 illustrates an exemplary database of codes and cleaning methods.

TABLE 1

| Code | Cleaning Method |
|---|---|
| 001 | Waxing |
| 002 | Vacuuming |
| 003 | Intense vacuuming |

When the automatic cleaning device determines 210 the cleaning method, it may apply 215 the cleaning method to the surface. In an embodiment, an automatic cleaning device may always apply 215 the same cleaning method each time it encounters a particular RFID tag.

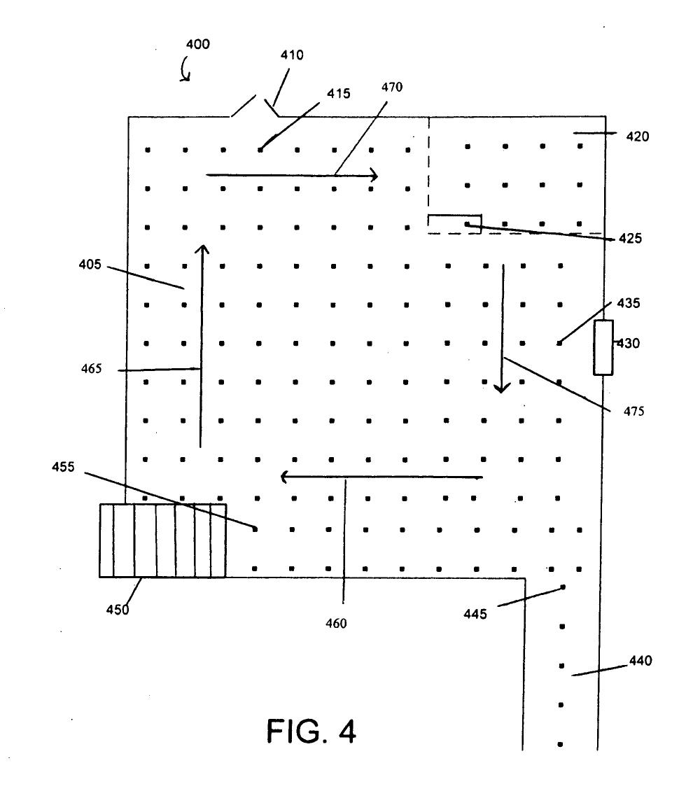

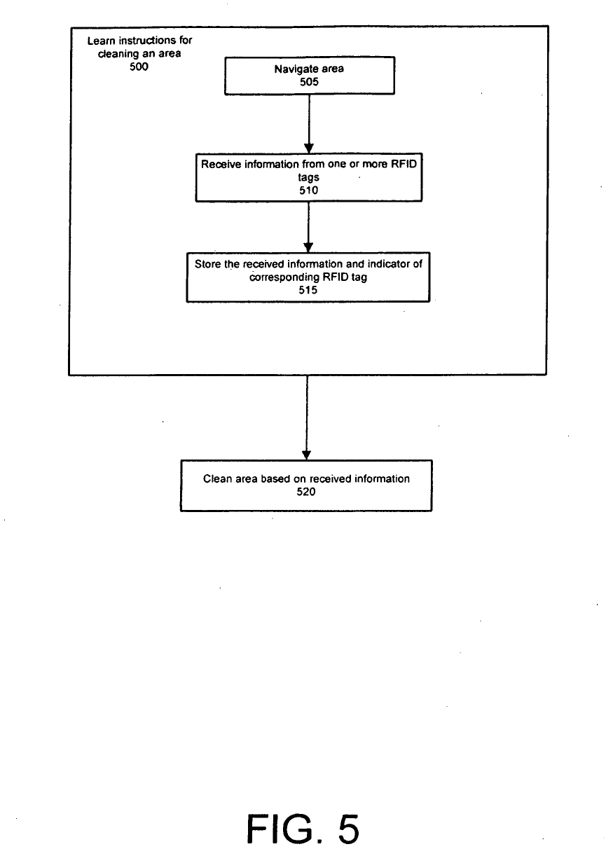

FIG. 4 depicts an exemplary area 405 to be cleaned according to an embodiment. FIG. 5 illustrates an flow chart of a method of cleaning the area of FIG. 4 according to an embodiment. As illustrated by FIG. 4 and FIG. 5, the automatic cleaning device may learn 500 a set of instructions associated with cleaning an area. The automatic cleaning device may learn 500 these instructions by navigating 505 the area and receiving 510 information from one or more encountered RFID tags. In an embodiment, the automatic cleaning device may store 515 the received information and an indicator of the RFID tag from which it received the information. The automatic cleaning device may then clean 520 the area based on the received information.

For example, referring to FIG. 4, the automatic cleaning device may navigate 505 the illustrated path 460, 465, 470, 475 around the area 400. In an embodiment, the navigation route may be predefined. As the automatic cleaning device proceeds along this route, it may encounter one or more RFID tags 445, 455, 415, 425, 435 positioned in the vicinity of one or more surfaces 440, 450, 410, 420, 430 to be cleaned. The automatic cleaning device may receive 510 information from the encountered RFID tags 445, 455, 415, 425, 435 regarding how the corresponding surface 440, 450, 410, 420, 430 is to be cleaned. For example, as the automatic cleaning device proceeds down a hallway 440, it may encounter an RFID tag 445. The automatic cleaning device may receive 510 one or more instructions from this RFID tag 445 regarding how to clean the hallway. For example, it may be instructed to vacuum and mop the hallway because the surface is hardwood. In addition, the automatic cleaning device may be instructed to perform an intense cleaning because the hallway is located in a high traffic area.

In an embodiment, the automatic cleaning device may develop its memory by storing the received instructions and an indicator of the corresponding RFID tag. When the automatic cleaning device subsequently encounters the RFID tag, it may apply the same cleaning method. For example, when the automatic cleaning device subsequently encounters the RFID tag 445 located in the hallway 440, it may automatically vacuum and mop the surface without having to match the code associated with the RFID tag 445 to the instructions for performing the cleaning method.

In an embodiment, the automatic cleaning device may apply a cleaning method for a defined period of time. For example, referring to FIG. 4, an automatic cleaning device may clean high traffic areas, such as areas near hallways 440, stairways 450, elevators 430 and doorways 410, for a longer period of time than other areas. In an embodiment, an automatic cleaning device may clean an area for a defined period of time based on the surface type of the area. For example, an automatic cleaning device may clean carpeted areas for ten minutes, hardwood areas for eight minutes and tiled areas for six minutes. Alternatively, each area may have a defined period of cleaning time associated with it.

In an embodiment, a user may input a cleaning time associated with one or more areas. For example, a user may instruct the automatic cleaning device to clean an area by a staircase for five minutes and a hallway area for three minutes. In an embodiment, a user may input a cleaning time associated with one or more surface types. For example, a user may instruct the automatic cleaning device to clean all hardwood areas for ten minutes, all carpeted areas for eight minutes and all tiled areas for six minutes.

In an embodiment, an automatic cleaning device may apply a cleaning method until it receives a different code from an RFID tag. For example, the automatic cleaning device may navigate a predefined course around a defined area. When the automatic cleaning device receives a code from an RFID it encounters on its course, the automatic cleaning device may apply the cleaning method corresponding to the code until it encounters an RFID tag having a different code.

In an embodiment, an automatic cleaning device may apply a cleaning method to a particular area a defined number of times. For example, an automatic cleaning device may be instructed to vacuum a certain carpeted area twice.

Referring back to FIG. 2, in an embodiment, one or more reports may be generated 220 when cleaning of an area is completed. The reports may be include the areas that were cleaned, the areas that were missed, a time associated with cleaning one or more areas, a total cleaning time and/or the like.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of cleaning a surface using an automatic cleaning device, the method comprising:
learning, by an automatic cleaning device, one or more cleaning methods, wherein each cleaning method is associated with a code corresponding to a radio frequency identification tag positioned in a vicinity of a surface to be cleaned;
receiving, by the automatic cleaning device, a target code from a target radio frequency identification tag positioned in a vicinity of a target surface to be cleaned;
determining the cleaning method associated with the target code; and
applying the associated cleaning method to the target surface when the target radio frequency identification tag is detected.

2. The method of claim 1, wherein learning one or more cleaning methods comprises:
receiving, by the automatic cleaning device, one or more instructions from a user, wherein the instructions instruct the automatic cleaning device to perform the one or more cleaning methods;
storing one or more of the received instructions, the one or more cleaning methods and the associated codes.

3. The method of claim 1, wherein learning one or more cleaning method comprises:
navigating one or more surfaces having one or more radio frequency identification tags; and
for each encountered radio frequency identification tag:
receiving a code from the radio frequency identification tag,
mapping the received code to one or more instructions for performing a cleaning method, and
storing one or more of the received code, the one or more instructions and the associated cleaning method.

4. The method of claim 1, wherein applying the associated cleaning method comprises:
applying the associated cleaning method for a defined period of time.

5. The method of claim 1, wherein applying the associated cleaning method comprises:
applying the associated cleaning method until a different code is received.

6. The method of claim 1, wherein applying the associated cleaning method comprises:
applying the associated cleaning method a defined number of times.

7. The method of claim 1, further comprising:
generating a report when the applying is completed, wherein the report comprises one or more of the following:
one or more surfaces that were cleaned;
one or more surfaces that were not cleaned;
a time associated with cleaning one or more surfaces, and
a total cleaning time.

8. A method of learning, by an automatic cleaning device, how to clean a surface, the method comprising:
receiving one or more instructions for cleaning a surface, wherein the instructions instruct the automatic cleaning device to apply a cleaning method to the surface, wherein the cleaning method is associated with a code; and
storing one or more of the received instructions, the cleaning method and the associated code.

9. The method of claim 8, wherein receiving one or more instructions comprises receiving one or more instructions from a user.

10. The method of claim 8, wherein receiving one or more instructions comprises:
navigating one or more surfaces having one or more radio frequency identification tags; and
for each encountered radio frequency identification tag:
determining whether the radio frequency identification tag is new;
receiving a code from the radio frequency identification tag;
mapping the received code to one or more instructions for performing a cleaning method, and
for each encountered radio frequency identification tag that is new, storing one or more of the received code, the one or more instructions and the associated cleaning method.

11. The method of claim 10, further comprising:
for one or more encountered radio frequency identification tags, storing one or more of the following:
a date that the automatic cleaning device encountered the encountered radio frequency identification tag, and
a time that the automatic cleaning device encountered the encountered radio frequency identification tag.

12. The method of claim 10, further comprising:
for one or more encountered radio frequency identification tags, storing one or more of the following on the encountered radio frequency identification tag:
a date that the automatic cleaning device encountered the encountered radio frequency identification tag, and
a time that the automatic cleaning device encountered the encountered radio frequency identification tag.

13. The method of claim 8, wherein the storing comprises storing one or more of the received instructions, the cleaning method and the associated code on a computer-readable storage medium associated with the automatic cleaning device.

14. The method of claim 8, further comprising applying the cleaning method to a surface when the associated code is received.

15. A method of learning, by an automatic cleaning device, how to clean a surface, the method comprising:
navigating a surface having one or more radio frequency identification tags; and
for each encountered radio frequency identification tag:
receiving a code from the radio frequency identification tag;
mapping the received code to one or more instructions for performing a cleaning method, and
storing one or more of the received code, the one or more instructions and the associated cleaning method.

16. The method of claim 15, wherein receiving a code comprises:
determining whether the encountered radio frequency identification tag is new based on the received code;
adding the encountered radio frequency identification tag to a computer-readable storage medium associated with the automatic cleaning device; and
updating the computer-readable storage medium with one or more of the following:
a date the automatic cleaning device encountered the encountered radio frequency identification tag, and
a time the automatic cleaning device encountered the encountered radio frequency identification tag.

17. The method of claim 15, wherein the storing comprises storing one or more of the received instructions, the cleaning method and the associated code on a computer-readable storage medium associated with the automatic cleaning device.

18. The method of claim 15 wherein the storing comprises storing one or more of the received instructions, the cleaning method and the associated code on the encountered radio frequency identification tag.

19. The method of claim 15, further comprising applying the cleaning method to the surface when the associated code is received.
